(19) United States
(12) Patent Application Publication
(10) Pub. No.: US 2015/0107076 A1
(43) Pub. Date: Apr. 23, 2015

(54) Cylindrical Surface Repair Method

(71) Applicant: Ford Global Technologies, LLC, Dearborn, MI (US)

(72) Inventors: Clifford E. Maki, New Hudson, MI (US); Keith Raymond Bartle, Sterling Heights, MI (US); David Alan Stephenson, Detroit, MI (US)

(73) Assignee: Ford Global Technologies, LLC, Dearborn, MI (US)

(21) Appl. No.: 14/057,446

(22) Filed: Oct. 18, 2013

(51) Int. Cl. B23P 6/00

(52) U.S. Cl. CPC B23P 6/00
USPC 29/402.18

(57) ABSTRACT

A method for repairing or resurfacing an inner cylindrical surface of a workpiece having an original coating applied over an original-roughened surface. The original workpiece has The method includes repair-boring the surface to a repair-bored diameter greater than a maximum diameter of the original-roughened surface. Next, the repair-bored surface is repair-roughened. A repair-coating is then applied over the repair-roughened surface. Finally, the repair-coated surface is machined to a final-repaired diameter. The workpiece may be an engine block and the inner cylindrical surface may be a cylinder bore.

### TECHNICAL FIELD

The present invention relates to a process for repairing cylindrical bore surfaces that have previously had a thermally-sprayed coating applied over a roughened surface.

### BACKGROUND

This application is related to the application having the Ser. No. 13/913,865, filed Jun. 10, 2013, and incorporated by reference in its entirety herein. This application is also related to the application having the Ser. No. 13/461,160, filed May 1, 2012, and incorporated by reference in its entirety herein.

Automotive engine blocks include a number of cylindrical bores in which the pistons travel. The inner surface of each cylinder bore is machined so that the surface is suitable for use in automotive applications, e.g., exhibits suitable wear resistance and strength. The machining process may include roughening the inner surface, applying a metallic coating to the roughened surface, and honing the metallic coating to obtain a finished inner surface.

If any of the manufacturing steps are not performed properly the bore may not be of the required dimensions, which in the past has resulted in either an expensive repair process or complete scrapping of the engine block.

### SUMMARY

A method of resurfacing an inner cylindrical surface of a workpiece having an original coating applied over an original-roughened surface is disclosed. The method includes repair-boring the surface to a repair-bored diameter greater than a maximum diameter of the original-roughened surface. Next, the repair-bored surface is repair-roughened. A repair-coating is then applied over the repair-roughened surface. Finally, the repair-coated surface is machined to a final-repaired diameter.

In one or more embodiments, the repair-bored diameter is larger than a nominal maximum diameter of the original-roughened surface by an amount to ensure that the repair-boring step results in complete removal of the original coating.

In one or more embodiments, the repair-bored diameter is larger than the nominal maximum diameter of the original-roughened surface by an amount in the approximate range of from 50 μm to 70 μm.

In one or more embodiments, the repair-bored diameter is larger than the nominal maximum diameter of the original-roughened surface by 60 μm.

In one or more embodiments, the repair-roughened surface comprises a plurality of annular grooves and alternating peaks in the repair-bored surface, the peaks having undercut grooves.

In one or more embodiments, the final-repaired diameter is equal to an original diameter of the inner cylindrical surface.

### BRIEF DESCRIPTION OF THE DRAWINGS

FIG. 1A depicts a top view of a joint or deck face of an exemplary engine block of an internal combustion engine;

FIG. 1B depicts an isolated, cross-sectional view of a cylinder bore taken along line 1B-1B of FIG. 1A;

FIG. 2A depicts a cross-sectional view of a cylinder bore prior to the start of the disclosed resurfacing process;

FIG. 2B depicts the cylinder bore after a repair-boring step;

FIG. 2C depicts the cylinder bore after a repair-roughening step;

FIG. 2D depicts the cylinder bore after a repair-coating step; and

FIG. 2E depicts the cylinder bore after a final-machining step.

### DETAILED DESCRIPTION

Reference will now be made in detail to embodiments known to the inventors. However, it should be understood that disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention.

Except where expressly indicated, all numerical quantities in this description indicating amounts of material are to be understood as modified by the word “about” in describing the broadest scope of the present invention.

Automotive engine blocks include a number of cylindrical engine bores. The inner surface of each engine bore is machined so that the surface is suitable for use in automotive applications, e.g., exhibits suitable wear resistance and strength. The machining process may include roughening the inner surface and subsequently applying a metallic coating to the roughened surface and subsequently honing the metallic coating to obtain a finished inner surface with requisite strength and wear resistance. Because of the precision required, it is not unusual for one of the steps to result in a bore that does meet dimensional tolerances.

Embodiments disclosed herein provide processes for repairing or resurfacing the inner surface of cylindrical bores, e.g., engine bores, that have previously had a metallic coating, e.g., thermal- or plasma-spray coating, applied onto a roughened inner surface.

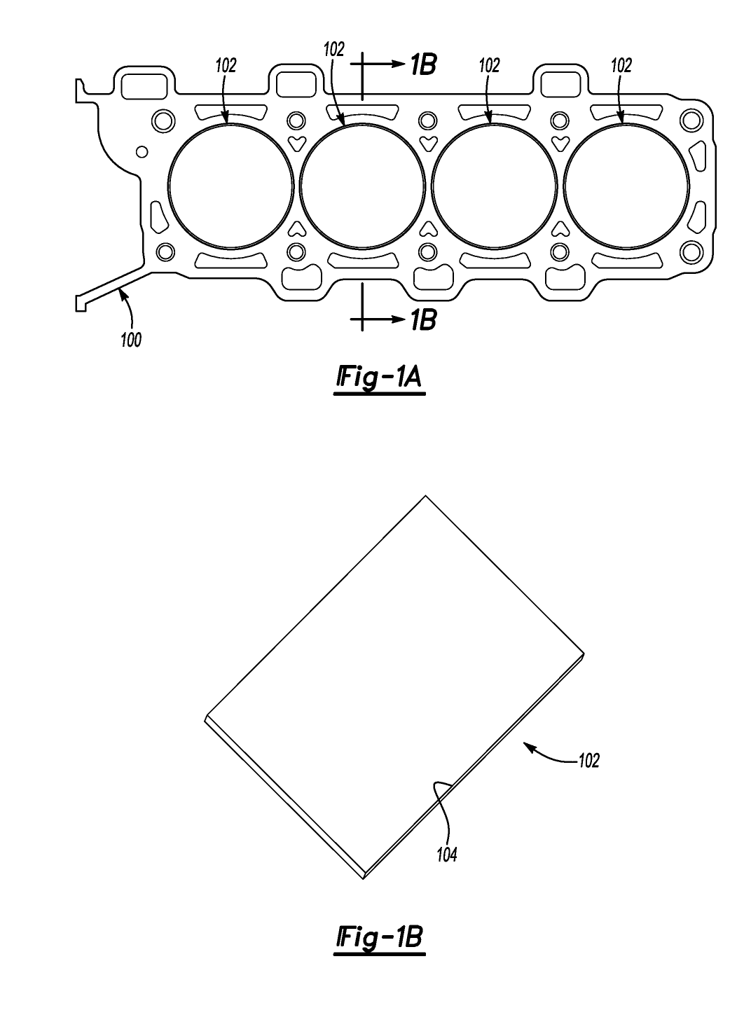

FIG. 1A depicts a top view of a joint face of an exemplary engine block 100 of an internal combustion engine. The joint face is the surface to which a cylinder head (not shown) is attached. The engine block includes cylinder bores 102. FIG. 1B depicts an isolated, cross-sectional view of cylinder bore 102 taken along line 1B-1B of FIG. 1A. Cylinder bore 102 includes an inner surface portion 104, which may be formed of a metal material, such as, but not limited to, aluminum, magnesium or iron, or an alloy thereof, or steel. In certain applications, aluminum or magnesium alloy may be utilized because of their relatively light weight compared to steel or iron. The relatively light-weight aluminum or magnesium alloy materials may permit a reduction in engine size and weight, which may improve engine power output and fuel economy. Such light-weight alloys may, however, not have sufficient/required resistance to the wear sustained by the cylinder bore during piston travel. It is known to apply a coating to the interior of the cylinder bores, the coating make of a material that provides increased required wear resistance (and other improved characteristics?) compared with the cast, lightweight alloys.

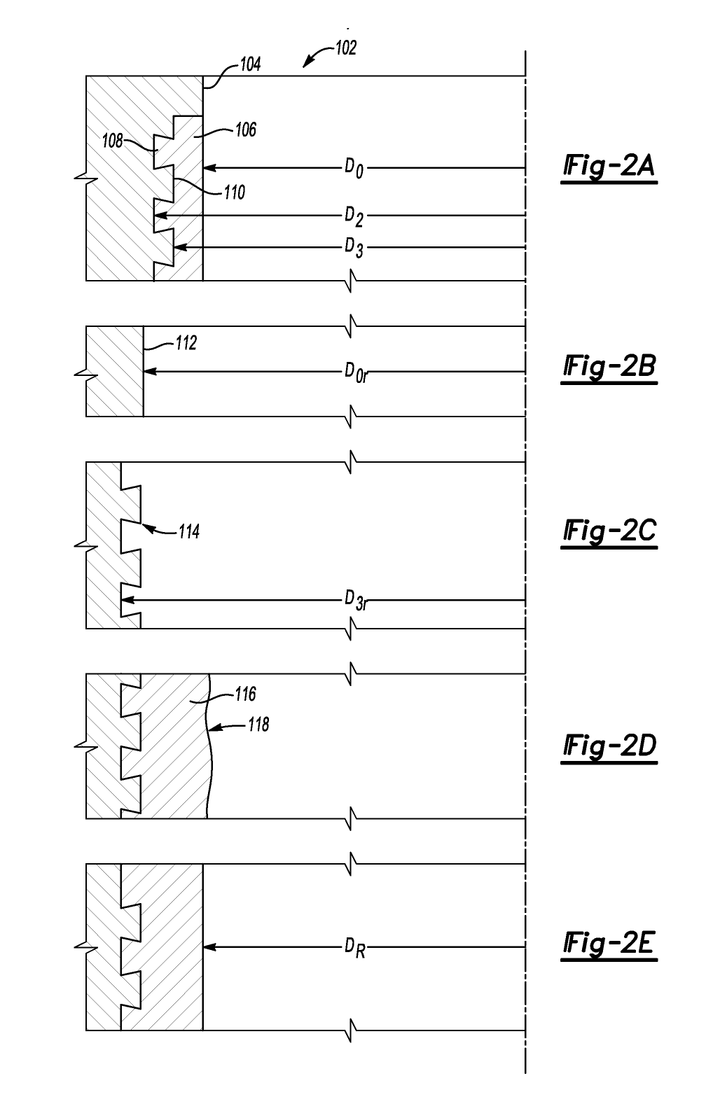

FIG. 2A depicts a cross-sectional view of the cylinder bore 102 prior to the start of the disclosed resurfacing process. Bore inner surface 104 has a metallic coating 106 applied over at least a portion thereof to form a wear-resistant lining. The finished diameter of the original cylinder bore is referred to as D₀. Coating 106 is applied over an original-roughened surface to improve adhesion of the coating, as is well known in the art. The term “original-roughened” is used herein to describe the surface roughening performed during the original manufacture of the cylinder, and to distinguish from the repair-roughening performed during the resurfacing process of the present invention, as described below.

The original-roughened surface may be formed by any known method and, in the shown exemplary embodiment, generally comprises a series of alternating grooves 108 and teeth 110. In one non-limiting example, nominal diameter D₂ measured to the tops of the teeth 110 (minimum inside diameter) is D₀+300 μm and the maximum depth of the grooves 108 extends approximately 120 μm below the tops of the teeth. This yields a maximum nominal diameter of the original-roughened surface D₃=D₀+540 m.

The metallic coating 106 may be applied by means of a plasma wire arc thermal spay system such as is disclosed in US Patent Application Publication US2012/0018407A1. In the embodiment depicted in FIG. 2, coating 106 does not extend to the top or cylinder head surface of the block , but rather covers only an axial length of the bore which will be contacted by a piston ring (not shown) during engine operation.

In at least one known manufacturing method, metallic coating 106 is applied over the original-roughened surface and a honing process then removes any excess thickness of the coating to leave the bore with original diameter D₀. There may be additional machining steps performed to achieve the original diameter D₀.

Various machining processes are known that may be used to produce the cylinder bore geometry shown. The particular geometry comprises teeth that are formed to have undercuts which improve adhesion. Such geometry may be formed in accordance with U.S. patent application Ser. No. 13/913,865, assigned to the assignee of the present application and the disclosure of which is incorporated herein by reference. This production method disclosed therein includes forming rectangular teeth and grooves, followed by a deforming step in which the flat peaks between adjacent grooves are deformed to obtain deformed peaks in which each peak includes a pair of undercuts.

It is possible for one or more of the process steps used to manufacture the coated cylinder surface such as shown in FIG. 2A to be completed improperly, making the resulting engine block unusable. In such a case, a repair or resurfacing procedure is necessary to avoid completely scrapping the block.

Resurfacing a grooved-and-coated bore of the general type shown in FIG. 2A is accomplished by performing the following steps:
1. Repair-bore the cylinder to a diameter large enough to remove all of the original coating material;
2. Mechanically repair-roughen the repair-bored surface;
3. Apply a repair-coating over the repair-roughened surface to a thickness to establish a diameter smaller than the desired final diameter; and
4. Machine the repair-coating to the final diameter.

The first step in the resurfacing process is to repair-bore the cylinder to a diameter D₀ᵣ (see FIG. 2B) sufficiently large to remove all or substantially all of the original coating material 106 applied over the original-roughened surface. This step forms a repair-bored surface 112. It has been found that complete removal of the original coating material 106 will result in the best adhesion of the repair-coating applied in step three of the process (as explained below).

Repair-bore diameter D₀ᵣ is preferably the smallest diameter necessary to remove substantially the entire original coating. Due to inevitable alignment and positioning errors inherent in normal manufacturing processes, to remove all coating material it is generally necessary to select a repair-bore diameter D₀ᵣ somewhat larger than the nominal groove-bottom diameter D₃. As will be apparent to a person of skill in the art, the amount by which D₀ᵣ should exceed D₃ may also depend upon factors such as manufacturing tolerances. In testing of the disclosed procedure using a cylinder bore having the example dimensions described above, it has been found that to reliably remove all original coating material, it is necessary to repair-bore to D₀ᵣ of at least 60 μm greater than D₃, or at least 600 μm over the original diameter D₀ in the dimensional example discussed above.

A systematic procedure that may be used is to initially bore to 500 μm (in the current example) greater than the original honed diameter D₀, then enlarge the bore diameter 100 μm per pass in one or more subsequent passes until all coating material 106 is removed. Any coating remaining after a boring pass is easily recognized by visual inspection, appearing as a series of circumferential bands (typically darker than the base material of the block) once the roughening profile is reached.

Different roughening methods are known, and the particular original-roughening method determines how far below the original diameter D₀ the coating material extends, and thus how large D₀ᵣ must be to remove all of the original coating.

Step #2 of the process is to repair-roughen the relatively smooth repair-bored surface 112, thereby forming the repair-roughened surface 114 shown in FIG. 2C. The repair-roughening may be accomplished by any known process. The example of a repair-roughened surface 114 shown in FIG. 2C has a groove-tooth pattern with undercuts similar to those present in the original-roughened surface shown in FIG. 2A. Since the repair-bored surface 114 is the same material and only slightly greater in diameter than the surface on which the original-roughening was performed, generally similar tools and techniques may be used in repair-roughening as were used in the original-roughening. The maximum nominal diameter (to the bottoms of the grooves) is indicated in FIG. 2C as D₃ᵣ.

Step #3 of the process is to apply a repair-coating 116 over the repair-roughened surface 114 to form a repair-coated surface 118. See FIG. 2D. The tools, materials, and techniques used to apply the repair-coating 116 may be generally similar to those used to apply the original coating 106. The repair-coating 116 is, however, thicker than the original coating 106 as necessitated by the over-boring step and the requirement that repaired bore have a finished diameter that is at least nominally equal to original diameter D₀.

Step #4 of the process is to machine the repair-coated surface 118 to a final-repaired diameter D_{R}. See FIG. 2E. This machining step may comprise honing and/or any process appropriate to achieve the desired final diameter and smoothness. The final-repaired diameter D_{R} will usually be identical to the original diameter D₀ that existed (and/or that was desired but not achieved, necessitating the resurfacing process) prior to the resurfacing process. In general, the same machining tools and techniques may be used.

It should be noted that FIG. 2D illustrates the repair-coated surface 116 as being somewhat uneven and slightly thicker than the final-repaired diameter D_{R}, to make the minimum inside diameter of the bore smaller than the desired final diameter D₀.

An advantage of the disclosed process is that, in many cases the same tools used in the manufacture of the original cylinder bore may be used to carry out the resurfacing.

While the best mode for carrying out the invention has been described in detail, those familiar with the art to which this invention relates will recognize various alternative designs and embodiments for practicing the invention as defined by the following claims.

What is claimed:

1. A method of resurfacing an inner cylindrical surface of a workpiece, the surface having an original coating applied over an original-roughened surface, comprising:
repair-boring the workpiece to a repair-bored diameter greater than a maximum diameter of the original-roughened surface;
repair-roughening the repair-bored surface;
applying a repair-coating over the repair-roughened surface; and
machining the repair-coated surface to a final-repaired diameter.

2. The method of claim 1, wherein the repair-bored diameter is larger than a nominal maximum diameter of the original-roughened surface by an amount to ensure that the repair-boring step results in complete removal of the original coating.

3. The method of claim 2, wherein the repair-bored diameter is larger than the nominal maximum diameter of the original-roughened surface by an amount in the approximate range of from 50 μm to 70 μm.

4. The method of claim 3, wherein the repair-bored diameter is larger than the nominal maximum diameter of the original-roughened surface by 60 μm.

5. The method of claim 1, wherein the repair-roughening comprises:
forming a plurality of annular grooves and alternating peaks in the repair-bored surface; and
deforming the peaks to form undercut grooves.

6. The method of claim 5, wherein the grooves formed during the forming step comprise flat bottom surfaces.

7. The method of claim 5, wherein the peaks formed during the forming step comprise flat top surfaces.

8. The method of claim 1, wherein the final-repaired diameter is equal to an original diameter of the inner cylindrical surface.

9. A method of resurfacing an inner surface of a cylinder in an engine block, the surface having an original coating applied over an original-roughened surface, comprising:
repair-boring the block to a repair-bored diameter greater than a maximum diameter of the original-roughened surface to remove all of the original coating;
repair-roughening the repair-bored surface;
applying a repair-coating over the repair-roughened surface; and
machining the repair-coated surface to a final-repaired diameter, the final-repaired diameter equal to an original diameter of the inner surface.

10. The method of claim 9, wherein the repair-bored diameter is larger than a nominal maximum diameter of the original-roughened surface by an amount to ensure that the repair-boring step results in complete removal of the original coating.

11. The method of claim 10, wherein the repair-bored diameter is larger than the nominal maximum diameter of the original-roughened surface by an amount in the approximate range of from 50 μm to 70 μm.

12. The method of claim 11, wherein the repair-bored diameter is larger than the nominal maximum diameter of the original-roughened surface by 60 μm.

13. The method of claim 9, wherein the repair-roughening comprises:
forming a plurality of annular grooves and alternating peaks in the repair-bored surface; and
deforming the peaks to form undercut grooves.

14. The method of claim 13, wherein the grooves formed during the forming step comprise flat bottom surfaces.

15. The method of claim 13, wherein the peaks formed during the forming step comprise flat top surfaces.

16. A method of resurfacing an inner cylindrical surface of a workpiece, the surface having an original coating applied over an original-roughened surface, comprising:
repair-boring the workpiece to produce a repair-bored surface having a diameter greater than a maximum diameter of the original-roughened surface;
repair-roughening the repair-bored surface to produce a repair-roughened surface;
applying a repair-coating over the repair-roughened surface to produce a repair-coated surface; and
machining the repair-coated surface to a final-repaired diameter.
